(19) United States
(12) Patent Application Publication
(10) Pub. No.: US 2015/0347063 A1
(43) Pub. Date: Dec. 3, 2015

(54) PRINTER APPARATUS

(71) Applicant: TOSHIBA TEC KABUSHIKI KAISHA, Tokyo (JP)

(72) Inventor: Kengo Saga, Mishima-shi (JP)

(73) Assignee: TOSHIBA TEC KABUSHIKI KAISHA, Tokyo (JP)

(21) Appl. No.: 14/294,503

(22) Filed: Jun. 3, 2014

(51) Int. Cl. G06F 3/12; G06K 15/16

(52) U.S. Cl. CPC G06F 3/1208; G06F 3/125; G06K 15/16

(57) ABSTRACT

In accordance with one embodiment, a printer apparatus comprises a medium conveyance path configured to convey a booklet medium having a binding section parallel to the printing digit direction; a page recognition section configured to read page recognition information which is arranged on each page of the medium in advance; a printing section configured to carry out printing on the medium; and a page recognition section moving section configured to move the page recognition section in the printing digit direction of the medium based on the size information of the medium.

### FIELD

Embodiments described herein relate to a printer apparatus for recognizing a page code arranged on a booklet or paper.

### BACKGROUND

Currently, a printer is known which carries out printing on a booklet such as a passbook used by a financial institution. These booklets consist of a plurality of printing pages on each of which a plurality of lines of printing can be carried out.

If printing is carried out on the same line or the same page for several times, the characters are overlapped, which leads to a problem that the printing content is hard to read. Thus, it is necessary to know the printing is carried out to which page of the booklet, and a page code reading section is arranged on the conveyance path of the booklet to read the page mark arranged on the opened booklet, and the page which has been subjected to printing processing is prevented from being printed again using the information.

The printer for carrying out printing on the booklet is installed in an automatic teller machine. In recent years, the automatic teller machine is arranged not only in a bank, but also in a shopping center and the like, and the deposit processing of a plurality of bank accounts can be carried out through one automatic teller machine. However, the passbooks serving as the used booklets are different depending on different financial institutions. If the sizes of the passbooks are different, the positions of the page marks are also different accordingly, thus, a plurality of page code reading sections are needed in order to read a plurality of page mark positions, which leads to a high cost in the printer apparatus. Thus, a reading unit mounting section is formed over the entire width area of the medium conveyance path, and a page code reading section can be mounted in the mounting section as a unit. A method, that is, mounting and using the page code reading section at a position corresponding to the page mark, is known to cope with the different sizes of the passbooks without increasing the number of the page code reading sections.

However, though the increase in the number of page code reading sections is prevented, in a case where the sizes of the passbooks change frequently, it is necessary to mount the page code reading section at the position corresponding to the page mark every time the sizes change, which makes it difficult to cope with.

### BRIEF DESCRIPTION OF THE DRAWINGS

FIG. 1 is a constitution diagram illustrating the main portions of a printer apparatus according to the present embodiment;

FIG. 2 is a control block diagram of the printer apparatus according to the present embodiment;

FIG. 3 is a diagram illustrating the position relation between a booklet and a page code according to the present embodiment;

FIG. 4 is a diagram illustrating the position relation between the page code and a page code reading section according to the present embodiment;

FIG. 5 is a flowchart illustrating the movement of the page code reading section according to page code position information from the insertion of the booklet according to the present embodiment;

FIG. 6 is an illustration diagram illustrating a method of moving the page code reading section according to the present embodiment;

FIG. 7 is an illustration diagram illustrating the change in the sizes of booklets and the positions of the page code reading section according to a second embodiment;

FIG. 8 is a control block diagram of a printer apparatus according to the second embodiment;

FIG. 9 is a flowchart illustrating the movement of the page code reading section according to booklet end detection result from the insertion of the booklet according to the second embodiment;

FIG. 10 is an illustration diagram illustrating the position relation among the booklet end part, the page code and the page code reading section according to the second embodiment; and

FIG. 11A is an illustration diagram illustrating scanned image data in a case where there is no booklet when the booklet end part is detected in the page code reading section according to the second embodiment.

FIG. 11B is an illustration diagram illustrating scanned image data when the page code reading section passes through the paper side end according to the second embodiment.

FIG. 11C is an illustration diagram illustrating scanned image data in a case where a booklet exists when the booklet end part is detected in the page code reading section according to the second embodiment.

### DETAILED DESCRIPTION

In accordance with one embodiment, a printer apparatus comprises a medium conveyance path configured to convey a booklet medium having a binding section parallel to the printing digit direction; a page recognition section configured to read page recognition information which is arranged on each page of the medium in advance; a printing section configured to carry out printing on the medium; and a page recognition section moving section configured to move the page recognition section in the printing digit direction of the medium based on the size information of the medium.

### A First Embodiment

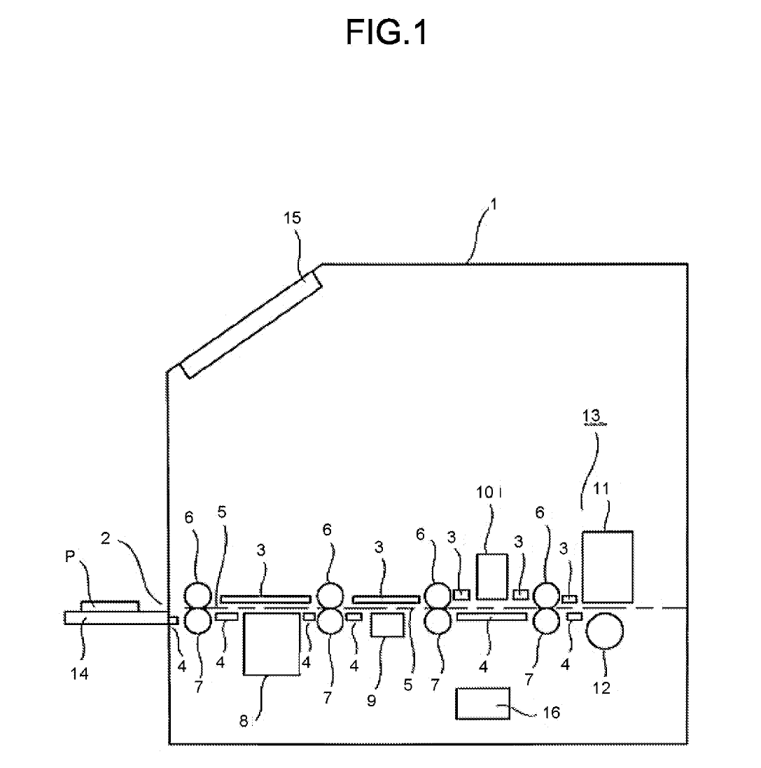

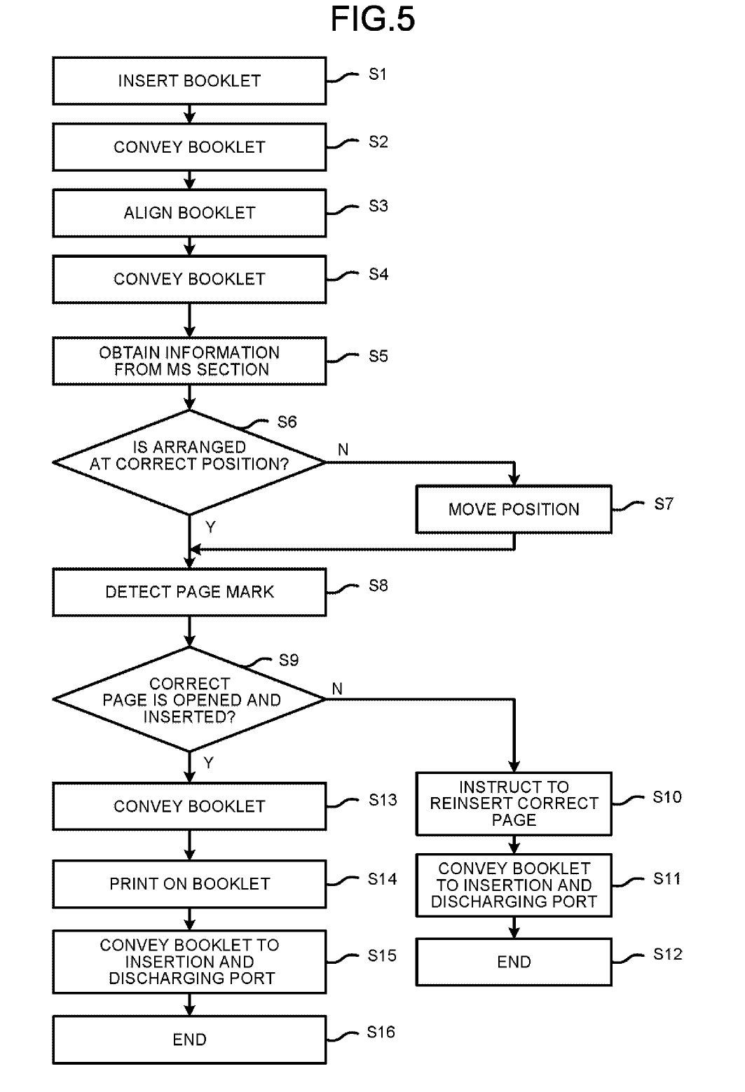

Hereinafter, the printer apparatus according to the first embodiment is described in detail with reference to FIG. 1-FIG. 6.

FIG. 1 is a constitution diagram illustrating the main portions of the printer apparatus according to the first embodiment. In addition, in the following description, the left side in FIG. 1 is referred to as an upstream side, and the right side in FIG. 1 is referred to as a downstream side.

In a printer apparatus 1, an insertion and discharging port 2 is arranged for inserting a booklet P such as a passbook, or discharging the printed booklet P to the outside of the printer apparatus 1.

Conveyance upper guides 3 and conveyance lower guides 4 are arranged to extend in the space from the insertion and discharging port 2 to the printer apparatus 1, and the space between the conveyance upper guides 3 and the conveyance lower guides 4 is regarded as a first booklet conveyance path 5 for conveying the booklet P.

At the downstream side of the insertion and discharging port 2, a feed roller 6 which can be rotated by a motor (not shown) is arranged opposite to an idle roller 7 across the booklet conveyance path 5. The feed roller 6 and the idle roller 7 are in pairs, so as to clamp and convey the booklet P. A plurality of pairs of feed roller 6 and idle roller 7 are arranged along the booklet conveyance path 5.

Further, an alignment section 8 is arranged at the downstream side of the insertion and discharging port 2. The alignment section 8 consisting of a paper position detection sensor, a shutter, a paper pinch mechanism, an alignment end wall and the like (not shown) corrects the skew, misalignment and the like of the booklet P inserted from the insertion and discharging port 2 and moves the booklet P to a preset position and attitude.

A MS (MAGNETIC STRIPE) reading/writing section 9 is arranged at the downstream side of the alignment section 8. The MS reading/writing section 9 carries out information reading and writing processing with a magnetic stripe section (not shown) arranged at the back side of the booklet P.

A page code reading section 10 is arranged at the downstream side of the MS reading/writing section 9. The page code reading section 10, which consists of an image capturing element such as a CCD (charge-coupled device) image sensor and the like, confirms the current opened page of the booklet P. Further, a sensor moving section 16 is arranged in the page code reading section 10 to move the page code reading section 10 in a direction orthogonal to the conveyance direction of the booklet P.

At the downstream side of the page code reading section 10, a dot head 11 is arranged opposite to a platen 12 across the booklet conveyance path 5. The dot head 11 and the platen 12 constitute a printing section 13 which carries out printing on the booklet P. Further, a display section 15 is arranged above the insertion and discharging port 2 of the printer apparatus 1 to display an error of the printer apparatus 1 and the like.

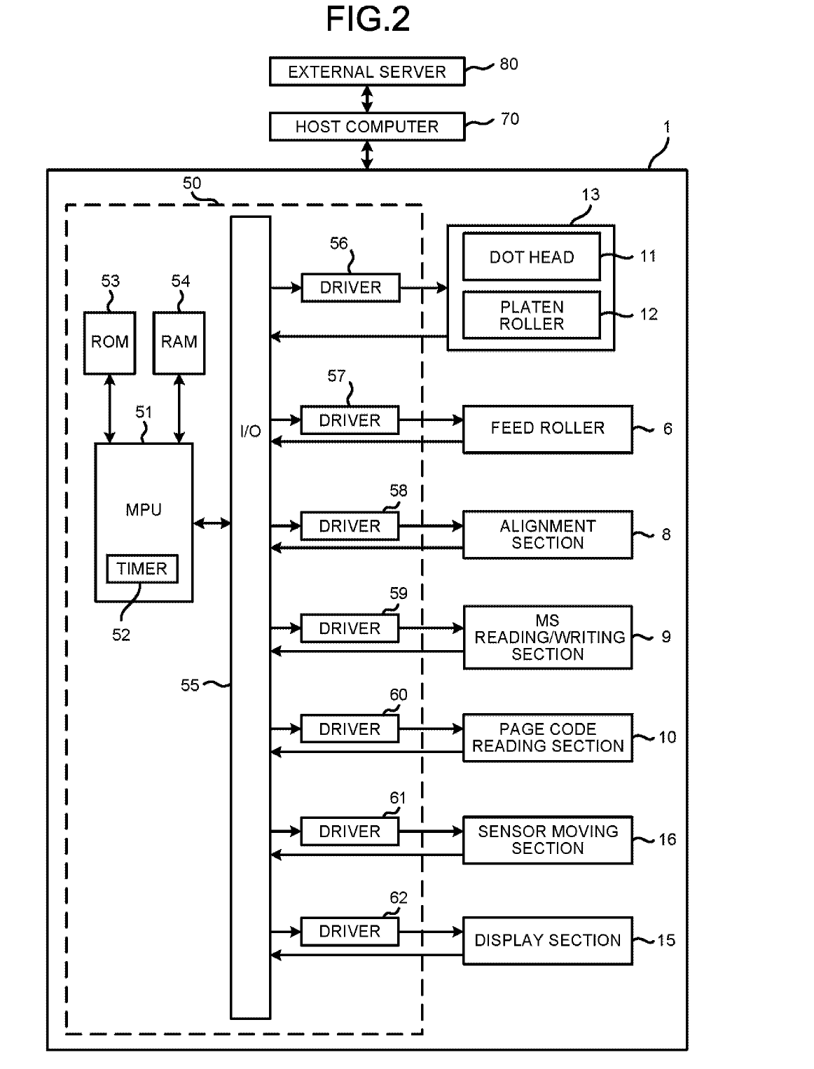

FIG. 2 is a block diagram illustrating the constitution of a control circuit of the printer apparatus 1 according to the present embodiment. A control section 50 carries out various controls on booklet conveyance, printing, booklet page code detection, booklet discharging, and condition display of the printer apparatus.

The control section 50 is constituted by, for example, a micro-computer which carries out connection with a host computer 70 and the execution of various controls. The host computer 70 is connected with an external server 80 of, for example, a financial institution managing the saving deposit information and the like.

A micro processing unit (MPU) 51 of the control section carries out, according to programs, various controls such as booklet conveyance control, printing control, booklet page code detection control and booklet discharging control, and operations.

The MPU 51 comprises a timer 52 serving as a unit for carrying out time setting and time control.

A ROM 53 and a RAM 54 are arranged in the control section 50 as primary storage units for storing control programs executed by the MPU 51 and data generated during a control process or an operation process.

The ROM 53 is a read-only memory in which control programs and tables and the like are stored, and the RAM 54 is a random access memory for storing the data generated during an operation process.

An input/output unit (I/O) 55 is arranged in the control section 50 to acquire various input data from the host computer 70 and export a control output of the control section 50 to the host computer 70. The I/O 55 is connected with the MPU 51, the ROM 53 and the RAM 54 via a bus line.

The I/O 55 is connected with a first, a second, a third, a fourth, a fifth, a sixth and a seventh driver 56, 57, 58, 59, 60, 61 and 62 serving as units for exporting a control output.

The first driver 56 supplies a required drive output for the printing section 13. The second driver 57 supplies a drive output for the feed roller 6. The third driver 58 supplies a drive output for the alignment section 8. The fourth driver 59 supplies a drive output for the MS reading/writing section 9. The fifth driver 60 supplies a drive output for the page code reading section 10. The sixth driver 61 supplies a drive signal for the sensor moving section 16. The seventh driver 62 supplies a drive signal for the display section 15.

The operations of the printer apparatus 1 are described below with reference to FIG. 1 and FIG. 3-FIG. 6. The printer apparatus 1 is, for example, incorporated in an automatic teller machine and used. The operations of the printer apparatus 1 are described by taking bookkeeping as an example.

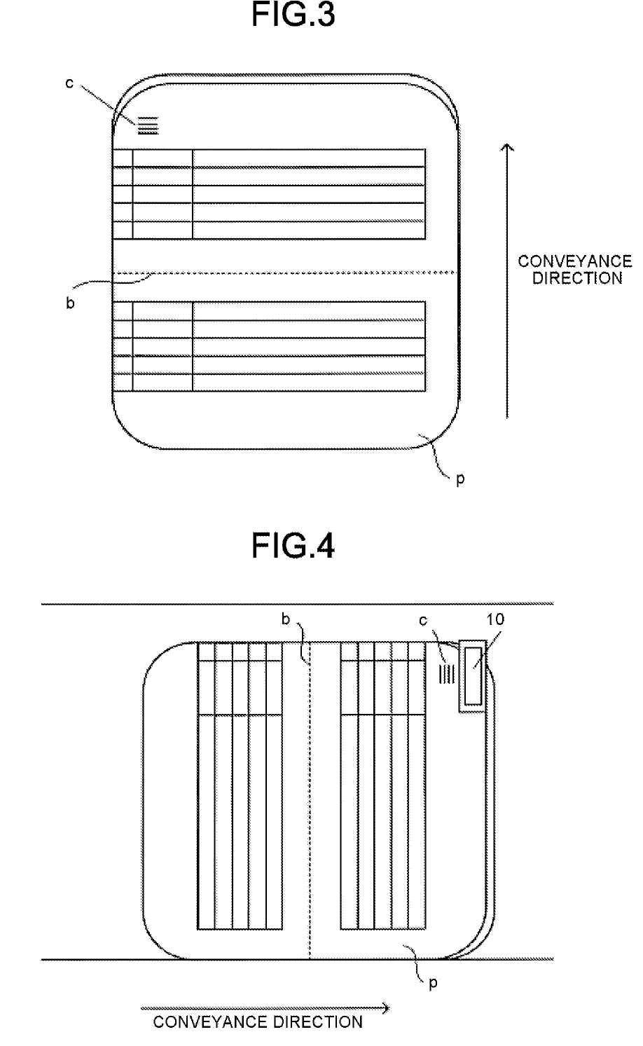

A user presses a button which is used when implementing bookkeeping on a screen (not shown) of the automatic teller machine. If the button for bookkeeping implementation is pressed, the control section 50 instructs the user to open the booklet P serving as a passbook and insert the opened booklet P through the insertion and discharging port 2 of the printer apparatus 1. As shown by an example shown in FIG. 3, a binding section b parallel to a printing digit direction is arranged on the booklet P, and a page code C for specifying the current opened page is arranged at a left upper end part of the booklet P in the conveyance direction.

The user opens the booklet P and inserts the opened booklet P through the insertion and discharging port 2 according to the instruction (ACT S1). The printer apparatus 1 rotates the feed roller 6 to convey the booklet P to the alignment section 8 through cooperation with the idle roller 7 (ACT S2). The alignment section 8 consisting of a paper position detection sensor, a shutter, a paper pinch mechanism, an alignment end wall and the like (not shown) corrects the skew, misalignment and the like of the booklet P conveyed to the alignment section 8 and aligns the booklet P to a preset position and attitude (ACT S3). In addition, as an existing mechanism is used as the alignment mechanism, the detailed description thereof is omitted.

The aligned booklet P is further conveyed to the MS reading/writing section 9 through the cooperation of the feed roller 6 and the idle roller 7 (ACT S4). During the conveyance towards the printing section 13, the MS reading/writing section 9 is arranged on the booklet conveyance path 5. A MS section (not shown) is arranged at the back side of the booklet P. User information and the like is written in the MS section as magnetic information. The control section 50 obtains, using the MS reading/writing section 9, the user information and the like from the MS section and obtains the transaction information of the user from the external server 80 of a financial institution and the like, while conveying the booklet P (ACT S5). In addition, as the exchange of information with the external server 80 of a financial institution and the like is existing content, the detailed description thereof is omitted. Further, the MS section stores the data of distance between the forgoing page code and the alignment end wall serving as a reference position of the booklet P in the printer apparatus 1 when correcting the skew, misalignment and the like of the booklet P and moving the booklet P to a preset position and attitude.

Next, the control section 50 compares the current distance between the image capturing element such as the CCD image sensor of the page code reading section 10 and the alignment end wall with the data of the distance between the page code and the alignment end wall acquired from the MS section, so as to confirm whether or not these distances are the same, that is, to confirm whether or not the page code reading section 10 is at a position where the page code reading section 10 can read the page code of the booklet P (ACT S6). Such a confirmation is carried out by comparing the distance information obtained by reading the MS section with the distance information indicating the current position of the page code reading section 10. If the page code reading section 10 is not at the readable position (NO in ACT S6), the sensor moving section 16 is driven to move the page code reading section 10 to the readable position (ACT S7).

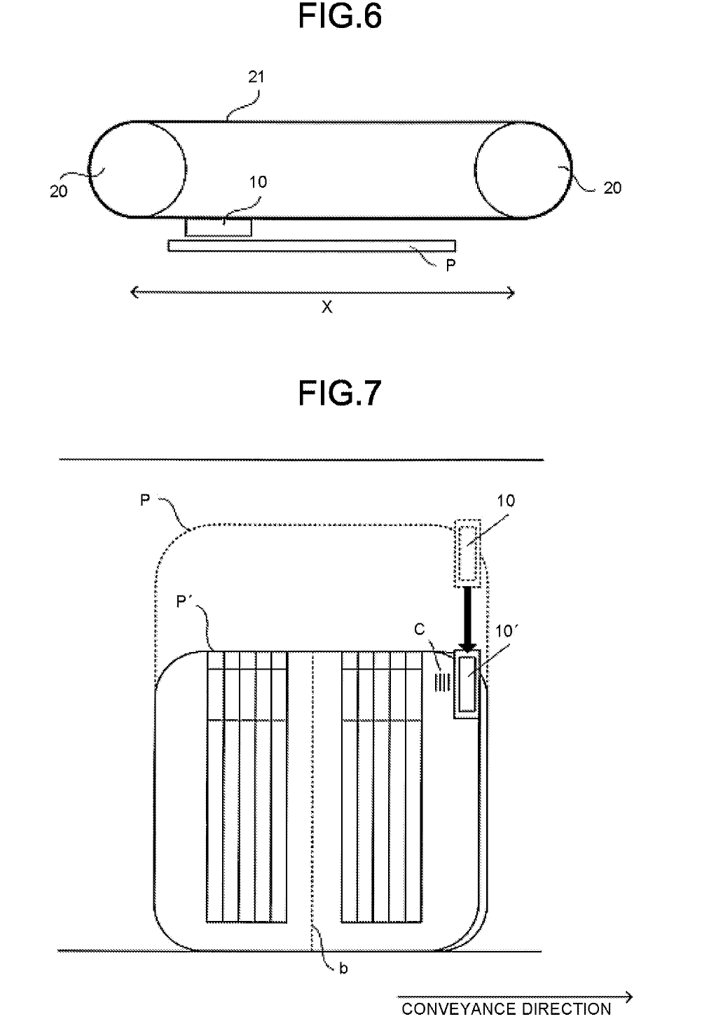

The method of moving the page code reading section 10 is described with reference to FIG. 6. FIG. 6 is a diagram of the page code reading section 10 viewed from the direction of the insertion and discharging port 2. The CCD image sensor and the like of the page code reading section are fixed on a belt 21, which is stretched by two pulleys 20. A rotation shaft of a moving motor (not shown) arranged in the sensor moving section 16 and a gear (not shown) are connected with each other to rotate the pulleys 20, and if the moving motor is rotated, the pulleys 20 are rotated. In this way, the belt 21 stretched by the pulleys 20 is rotated, thereby moving the page code reading section 10 fixed on the belt 21 in a direction X serving as the printing width direction of the booklet P. In addition, the belt 21 is rotated clockwise as the pulleys 20 are rotated clockwise, and the belt 21 is rotated anticlockwise as the pulleys 20 are rotated anticlockwise. That is, the moving direction of the page code reading section 10 can be changed by rotating the moving motor (not shown) arranged in the sensor moving section 16 in different directions.

After the sensor moving section 16 is driven to move the page code reading section 10 to the readable position (ACT S7), or if the page code reading section 10 is at the position where it can read the page code of the booklet P (YES in ACT S6), that is, as shown in FIG. 4, when the page code C and the page code reading section 10 are on the same line in the conveyance direction, the control section 50 drives the page code reading section 10 to read the page mark of the booklet P, while conveying the booklet P to the downstream side (ACT S8).

As stated above, the control section 50 has already acquired the transaction information of the user. The transaction information contains the information indicating how many pages of bookkeeping are carried out on the booklet P. The information is compared with the detected page obtained by the page code reading section 10 to confirm whether or not it is the correct page on which the current printing is supposed to be carried out (ACT S9). If the correct page is not opened and inserted (NO in ACT S9), a message instructing the user to open the correct page of the booklet and insert the booklet again is displayed on the display section 15 or the display section of the automatic teller machine in which the printer apparatus 1 is incorporated (ACT S10), and then the booklet P is reversely conveyed towards the insertion and discharging port 2 (ACT S11), and then the flow is ended (ACT S12).

If the correct page is opened and inserted (YES in ACT S9), the control section 50 rotates the feed roller 6 to convey the booklet P to the printing section 13 through cooperation with the idle roller 7 (ACT S13), and then carries out printing on the booklet P with the dot head 11 and the platen roller 12 (ACT S14). After the printing is carried out, the control section 50 stores the information indicating the current printing is carried out to which line of which page of the booklet P, and then rotates the feed roller 6 to reversely convey the booklet P towards the insertion and discharging port 2 through cooperation with the idle roller 7 (ACT S15), and then ends the processing (ACT S16).

Depending on different apparatuses, there exists a case where a page turning mechanism which automatically turns the page of the booklet is arranged inside the printer apparatus 1. In a case where the printer apparatus 1 is provided with the page turning mechanism, if it is confirmed that the correct page is not opened and inserted (NO in ACT S9), the booklet P may be conveyed to the page turning mechanism to be turned to the correct page and then be conveyed to the printing section 13 (ACT S13).

Further, though it is exemplified in the present embodiment that the width information of the booklet P is obtained from the information recorded in the MS section, the present invention is not limited to this. For example, in a case where the width of the booklet P can be obtained in advance, the information may be input from the host computer 70. The control section 50 may compare the input information with the current position of the page code reading section 10, and move the page code reading section 10 as needed.

As stated above, in accordance with the present embodiment, even if the sizes of the booklets P such as a passbook are different, the page code of the booklet can be read by moving the page code reading section 10, thus, it is possible to detect the page codes recorded on the booklets of different sizes without increasing the number of the page code reading sections.

### A Second Embodiment

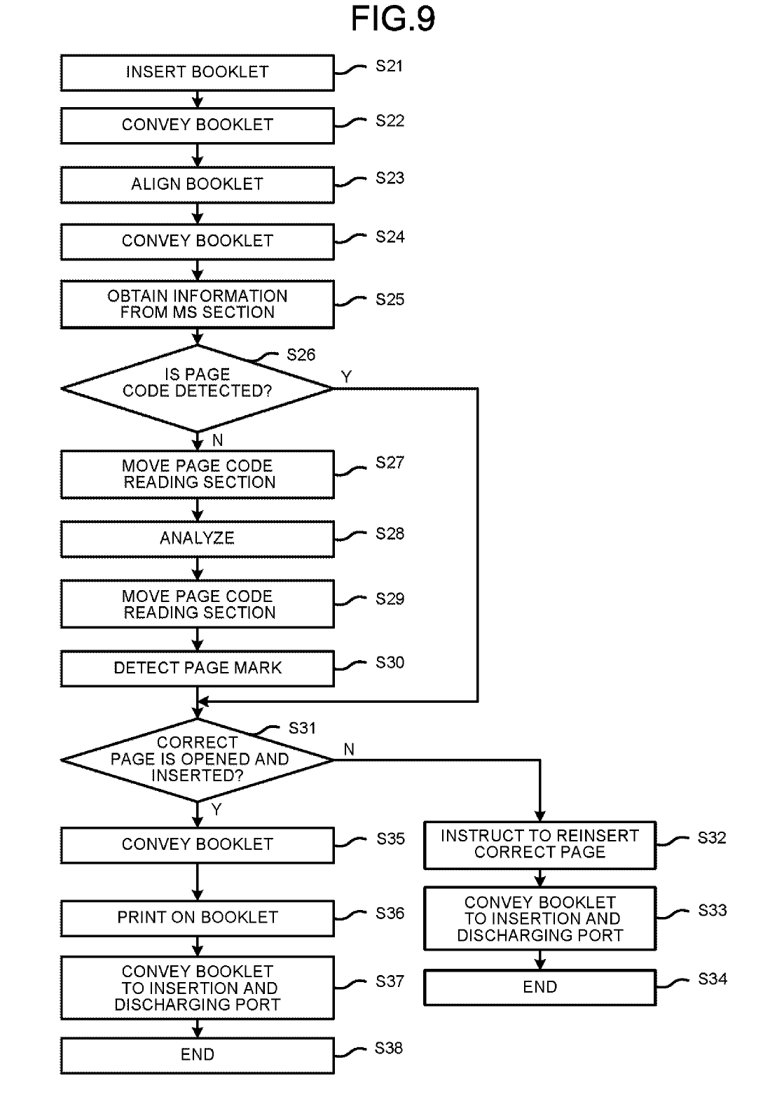

Hereinafter, a printer apparatus according to the second embodiment is described in detail with reference to FIG. 7-FIG. 11. In addition, the detailed description of the constitutions the same as those described in the first embodiment is omitted.

In the first embodiment, the position information of the page code recorded in the MS section or the position information of the page code input from the host computer 70 is used to move the page code reading section. However, as there are various types of booklets, there exists a case where the position information of the page code is not recorded in the MS section. Further, it is a large workload for the user to input the position information from the host computer 70.

In the second embodiment, the side end of the booklet P is detected by a CCD sensor and the like arranged in the page code reading section 10, and the page code reading section 10 is moved according to the page code existing at a preset position from the side end, in this way, the page code can be detected regardless of size of the booklet P.

The second embodiment describes an example in which bookkeeping processing is carried out on a booklet P′ of a minimum use size shown by the solid line in FIG. 7 after the bookkeeping on a booklet P of a maximum use size shown by the dotted line in FIG. 7.

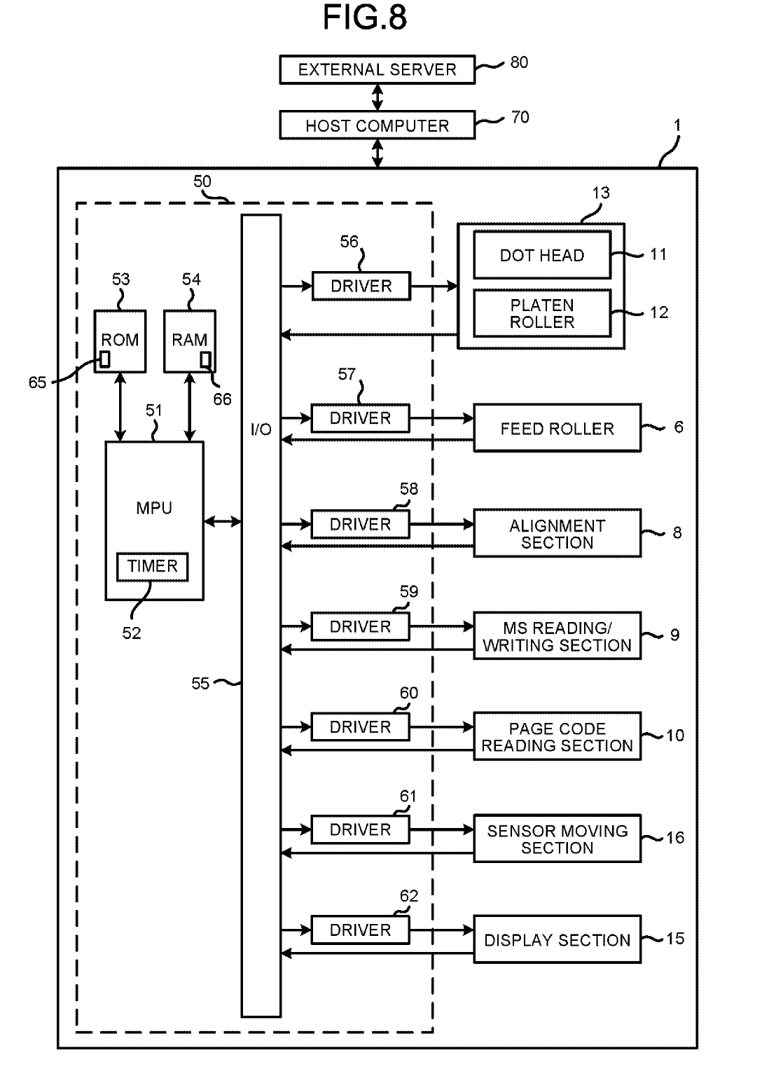

FIG. 8 is a block diagram illustrating the constitution of a control circuit of the printer apparatus 1 according to the second embodiment. Different from the first embodiment, in the second embodiment, a booklet side end analyzing section 65 (described later) is arranged in the ROM 53 to analyze the side end position of the booklet P, and a data storage section 66 (described later) is arranged in the RAM 54.

The user presses the button which is used when implementing bookkeeping on a screen (not shown) of the automatic teller machine. If the button for bookkeeping implementation is pressed, the control section 50 instructs the user to open the booklet P serving as a passbook and insert the opened booklet P through the insertion and discharging port 2 of the printer apparatus 1.

The user opens the booklet P and inserts the opened booklet P through the insertion and discharging port 2 according to the instruction (ACT S21). The printer apparatus 1 rotates the feed roller 6 to convey the booklet P to the alignment section 8 through cooperation with the idle roller 7 (ACT S22). The alignment section 8 consisting of a paper position detection sensor, a shutter, a paper pinch mechanism, an alignment end wall and the like (not shown) corrects the skew, misalignment and the like of the booklet P conveyed to the alignment section 8 and aligns the booklet P to the preset position and attitude (ACT S23). In addition, as an existing mechanism is used as the alignment mechanism, the detailed description thereof is omitted.

The aligned booklet P is further conveyed to the MS reading/writing section 9 through the cooperation of the feed roller 6 and the idle roller 7 (ACT S24). During the conveyance towards the printing section 13, the MS reading/writing section 9 is arranged on the booklet conveyance path 5. The MS section (not shown) is arranged at the back side of the booklet P. User information and the like is written in the MS section as magnetic information. The control section 50 obtains, using the MS reading/writing section 9, the user information and the like from the MS section and obtains the transaction information of the user from the external server 80 of a financial institution and the like, while conveying the booklet P (ACT S25). In addition, as the exchange of information with the external server 80 of a financial institution and the like is existing content, the detailed description thereof is omitted.

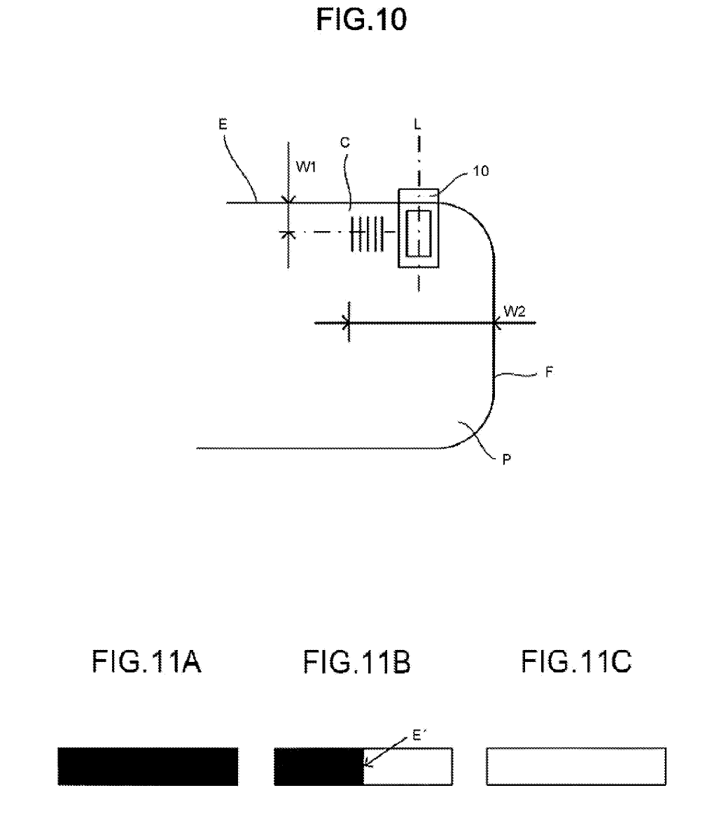

A position sensor (not shown) is arranged on the booklet conveyance path 5 of the printer apparatus 1, therefore, the printer apparatus 1 is in such a state in which it is possible to know the current position of the front end of the booklet P. In this state, the control section 50 rotates the feed roller 6 to convey the booklet P through cooperation with the idle roller 7 until the front end F of the booklet P is conveyed for a distance W2 from a line L serving as the center position of the page code reading section 10, and meanwhile, drives the page code reading section 10 to detect the page code C arranged on the booklet P (ACT S26). The distance W2 mentioned herein is the distance between the front end of the booklet P and the rear end of the page code C shown in FIG. 10. That is, in a case where the page code C and the page code reading section 10 are on the same line in the conveyance direction, if the front end F of the booklet P is conveyed for the distance W2 from the line L serving as the center position of the page code reading section 10, the page code reading section 10 certainly passes through the page code C.

If the page code C is not detected (NO in ACT S26), it is because the size of the currently used booklet P is different from that of the former booklet P used, and the page code C and the page code reading section 10 are not on the same line in the conveyance direction.

Next, the control section 50 moves, using the booklet side end analyzing section 65 arranged in the ROM 53, the page code reading section 10 from a position of the page code reading section 10 shown by a dotted line in FIG. 7 to a position of the page code reading section 10′ shown by a solid line in FIG. 7 in a range smaller than the effective field of view of the CCD image sensor arranged in the page code reading section 10, and meanwhile enables the page code reading section 10 to scan (ACT S27). In the scanning process, the page code reading section 10 passes through the paper side end E of the booklet P shown in FIG. 10. The obtained image data is temporarily stored in the data storage section 66 arranged in the RAM 54.

Next, the booklet side end analyzing section 65 analyzes the scanned image data temporarily stored in the data storage section 66 (ACT S28). The analyzing method is described below.

Examples of scanned image data are shown in FIG. 11A-FIG. 11C. The black part shown in FIG. 11A is the data in a case where there is no booklet P, the white part shown in FIG. 11C is the data in a case where the booklet P exists. The page code reading section 10 passes through the paper side end E as stated above. As shown in FIG. 11B, the data scanned when the page code reading section 10 passes through the paper side end E includes two parts, that is, the black part indicating no existence of booklet P and the white part indicating the existence of booklet P. The border line E′ of the black part and the white part in the data is the time when the page code reading section 10 passes through the paper side end E.

The booklet side end analyzing section 65 calculates the relative position between the paper side end E and the printer apparatus 1 according to the resolution of the image and the position of E′ indicating the switching from the black part to the white part in the image as shown by the border line E′ in FIG. 11B within the scanned image data temporarily stored in the data storage section 66.

The control section 50 drives, according to the data of the calculated relative position between the paper side end E and the printer apparatus 1, the sensor moving section 16 to move the page code reading section 10 to a position which is W1 away from the paper side end E (ACT S29). The W1 mentioned herein is the distance between the paper side end E and the center line of the page code C. In this way, the center line of the page code C and the page code reading section 10 are on the same line in the conveyance direction.

Next, the control section 50 drives the page code reading section 10 to read the page mark of the booklet P while conveying the booklet P to the downstream side (ACT S30).

As stated above, the control section 50 has already acquired the transaction information of the user. The transaction information contains the information indicating how many pages of bookkeeping are carried out on the booklet P. The information is compared with the detected page obtained by the page code reading section 10 to confirm whether or not it is the correct page on which the current printing is supposed to be carried out (ACT S31). If the correct page is opened and inserted, just the same as the first embodiment (YES in ACT S31), the booklet P is conveyed (ACT S35), printed by the printing section 13 (ACT S36), then discharged after the printing is completed (ACT S37), and then the flow is ended (ACT S38). If the correct page is not opened and inserted (NO in ACT S31), the user is instructed to open the correct page of the booklet and insert the booklet again (ACT S32), and the booklet P is discharged (ACT S33), and then the flow is ended (ACT S34).

As stated above, according to the present embodiment, even if the sizes of the booklets P such as a passbook are different, the page code of the booklet can be read by detecting the end part of the booklet with the booklet side end detection section such as the sensor moving section 16, the booklet side end analyzing section 65 and the data storage section 66 using the page code reading section 10, and then moving the page code reading section 10 to a position where it can read the page code, thus, even for the booklet P of which the size information is not stored in the MS section of the booklet P and the like, it is possible to detect the page codes recorded on the booklets of different sizes without increasing the number of the page code reading sections.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A printer apparatus comprising:
a medium conveyance path configured to convey an opened booklet medium having a binding section parallel to the printing digit direction from and to a booklet medium insertion and discharging port;
a medium conveyance path configured to convey an opened booklet medium having a binding section parallel to the printing digit direction from and to a booklet medium insertion and discharging port section;
a magnetic stripe reading and writing section configured to read a magnetic stripe section arranged on a back side of the opened booklet medium;
a page recognition section configured to read page recognition information arranged on each page of the opened booklet medium after the magnetic stripe section is read;
a printing section configured to carry out printing on each page of the booklet medium in accordance with the page recognition information for each page read by the page recognition section; and
a page recognition section moving section configured to move the page recognition section in the printing digit direction of the opened booklet medium based on size information of each page that is to be printed upon.

2. The printer apparatus according to claim 1, wherein
size information of the booklet medium is stored in the magnetic stripe section.

3. The printer apparatus according to claim 1, wherein
size information of the booklet medium is obtained from a host computer connected with the printer apparatus.

4. A printer apparatus comprising:
a medium conveyance path configured to convey an opened booklet medium having a binding section parallel to the printing digit direction from and to an opened booklet medium insertion and discharging port;
a page recognition section configured to read page recognition information which is arranged on each page of the medium in advance;
a printing section configured to carry out printing on a page of the medium in accordance with page recognition information of the page read by the page recognition section;
a booklet side end detection section configured to detect the side end of the booklet medium; and
a page recognition section moving section configured to move the page recognition section in the printing digit direction of the medium based on the side end position information of the medium detected by the booklet side end detection section.

5. The printer apparatus of claim 1 further comprising a page turning mechanism.

6. The printer apparatus of claim 4 further comprising a page turning mechanism.

7. The printer apparatus of claim 5, wherein if the page recognition information indicates that a correct page is not opened for printing, the opened booklet medium is conveyed to the page turning mechanism wherein the opened booklet medium is turned to a correct page and then conveyed to the printing section.

8. The printer apparatus of claim 6, wherein if the page recognition information indicates that a correct page is not opened for printing, the opened booklet medium is conveyed to the page turning mechanism wherein the opened booklet medium is turned to a correct page and then conveyed to the printing section.

9. The printer apparatus of claim 4, further comprising a magnetic stripe reading and writing section configured to read a magnetic stripe section arranged on a back side of the opened booklet medium.
